(19) United States
(12) Patent Application Publication
(10) Pub. No.: US 2024/0338804 A1
(43) Pub. Date: Oct. 10, 2024

(54) METHOD AND ELECTRONIC SYSTEM FOR HIGH DYNAMIC RANGE (HDR) IMAGING

(71) Applicant: MEDIATEK INC., Hsinchu City (TW)

(72) Inventors: Pin-Wei CHEN, Hsinchu City (TW); Keh-Tsong LI, Hsinchu City (TW); Shao-Yang WANG, Hsinchu City (TW); Chia-Hui KUO, Hsinchu City (TW); Hung-Chih KO, Hsinchu City (TW); Yun-I CHOU, Hsinchu City (TW); Yu-Hua HUANG, Hsinchu City (TW); Yen-Yang CHOU, Hsinchu City (TW); Chien-Ho YU, Hsinchu City (TW); Chi-Cheng JU, Hsinchu City (TW); Ying-Jui CHEN, Hsinchu City (TW)

(21) Appl. No.: 18/296,498

(22) Filed: Apr. 6, 2023

(51) Int. Cl. G06T 5/00; G06T 5/50; G06T 7/30

(52) U.S. Cl. CPC G06T 5/92; G06T 5/50; G06T 7/30; G06T 2207/20208; G06T 2207/20221

(57) ABSTRACT

A method for high dynamic range imaging is provided. The method includes the following stages. A first image from a first sensor capable of sensing a first spectrum is received. A second image from a second sensor capable of sensing a second spectrum is received. The second spectrum has a higher wavelength range as compared to the first spectrum. A first image feature from the first image and a second image feature from the second image are retrieved. The first and second images are fused by referencing the first image feature and the second image feature to generate a final image.

### CROSS REFERENCE TO RELATED APPLICATIONS

### Background of the Invention

### Field of the Invention

The present invention relates to an image processing method, and, in particular, to a method for high dynamic range (HDR) imaging.

### Description of the Related Art

HDR night scenes are common. Consider the following scenario: a person opens a door of a dark room to admit sunlight, or he suddenly turns on the lights in a dark place. The most challenging part of HDR night scenes is that it is difficult to see the bright and dark areas simultaneously. This is especially true when the exposure changes while the brightness of the environment changes. The image may be overexposed or underexposed during the exposure coverage, so that some of the information cannot be seen instantly when someone opens the door, or when the lights are suddenly turned on.

Some common methods of generating HDR images include capturing multiple short- and long-exposure images with a single camera, and then fusing these images into an HDR image. However, this method usually causes motion artifacting due to the motion area varying in different exposure images captured at different times using a single camera.

### BRIEF SUMMARY OF THE INVENTION

An embodiment of the present invention provides a method for high dynamic range (HDR) imaging. The method includes the following stages. A first image from a first sensor capable of sensing a first spectrum is received. A second image from a second sensor capable of sensing a second spectrum is received. The second spectrum has a higher wavelength range as compared to the first spectrum. A first image feature from the first image and a second image feature from the second image are retrieved. The first and second images are fused by referencing the first image feature and the second image feature to generate a final image.

According to the method for HDR imaging described above, the first image feature and the second image feature comprise color information, brightness information, and detail information.

According to the method for HDR imaging described above, the step of fusing the first image and the second image includes the following stages. The color information of the first image is referenced and the detail information in the second image is referenced to generate the final image . . . .

According to the method for HDR imaging described above, the step of fusing the first image and the second image includes the following stages. The color information and the detail information in the first images and parts of the detail information in the second images are referenced to generate the final image if the brightness information of the first images indicates that the first image is not overexposed. All of the detail information in the second image is utilized to generate the final image if the brightness information of the first image indicates that the first image is overexposed.

According to the method for HDR imaging described above, the step of fusing the first image and the second image includes the following stages. The brightness information of the first image is compared with a threshold value. The weightings of the detail information in the first image and the detail information in the second image as being referenced in the fusing step are changed based on the difference between the brightness information of the first image and the threshold value.

According to the method for HDR imaging described above, the greater the difference between the brightness information of the first image and the threshold value, the higher the weighting of the detail information in the first image; the less the difference between the brightness information of the first image and the threshold value, the higher the weighting of the detail information in the second image.

According to the method for HDR imaging described above, weightings of the color information in the first image and the color information in the second image as being referenced in the fusing step are changed based on the difference between the brightness information of the first image and the threshold value.

According to the method for HDR imaging described above, the detail information includes profiles, textures and edge sharpness.

The method for HDR imaging further includes the following stages. Image alignment on the first image and the second image is performed before retrieving the first image feature and the second image feature.

An embodiment of the present invention provides an electronic system. The electronic system includes a first sensor, a second sensor, and a processor. The first sensor outputs a first image according to a first spectrum. The second sensor outputs a second image according to a second spectrum. The second spectrum has a higher wavelength range as compared to the first spectrum. The processor performs the following steps. The first image from the first sensor capable of sensing the first spectrum is received. The second image from the second sensor capable of sensing the second spectrum is received. A first image feature from the first image and a second image feature from the second image are retrieved. The first and second images are fused by referencing the first image feature and the second image feature to generate a final image.

According to the electronic system described above, the electronic system further includes a light source. The light source emits a light within the second spectrum.

According to the electronic system described above, the first image feature and the second image feature comprise color information, brightness information, and detail information.

According to the electronic system described above, the processor references the color information of the first image and references the detail information in the second image to generate the final image.

According to the electronic system described above, the processor references the color information and the detail information in the first images and parts of the detail information in the second images to generate the final image if the brightness information of the first images indicates that the first image is not overexposed. The processor utilizes all of the detail information in the second image to generate the final image if the brightness information of the first image indicate that is the first image is overexposed.

According to the electronic system described above, the processor compares the brightness information of the first image with a threshold value. The processor changes the weightings of the detail information in the first image and the detail information in the second image as being referenced in the fusing step based on the difference between the brightness information of the first image and the threshold value.

According to the electronic system described above, the greater the difference between the brightness information of the first image and the threshold value, the higher the weighting of the detail information in the first image; the less the difference between the brightness information of the first image and the threshold value, the higher the weighting of the detail information in the second image.

According to the electronic system described above, weightings of the color information in the first image and the color information in the second image as being referenced in the fusing step are changed based on the difference between the brightness information of the first image and the threshold value.

According to the electronic system described above, the detail information comprises profiles, textures and edge sharpness.

According to the electronic system described above, the processor performs image alignment on the first image and the second image before retrieving the first image feature and the second image feature.

### BRIEF DESCRIPTION OF THE DRAWINGS

The present invention can be more fully understood by reading the subsequent detailed description and examples with references made to the accompanying drawings, wherein:

FIG. 1 is a flow chart of a method for high dynamic range (HDR) imaging in accordance with some embodiments of the present invention.

FIG. 2 is a detail flow chart of step S106 of the method for HDR imaging in FIG. 1 in the dark circumstance and the bright circumstance in accordance with some embodiments of the present invention.

FIG. 3 is a detail flow chart of step S106 of the method for HDR imaging in FIG. 1 in the transient circumstance in accordance with some embodiments of the present invention.

FIG. 4 is a detail flow chart of step S106 of the method for HDR imaging in FIG. 1 in the transient circumstance in accordance with some embodiments of the present invention.

FIG. 5A is a comparison diagram of the first image from the RGB sensor in the dark circuit circumstance and the bright circumstance in accordance with some embodiments of the present invention.

FIG. 5B is a comparison diagram of the final image output by the method for high dynamic range (HDR) imaging of the present invention in the dark circuit circumstance and the bright circumstance in accordance with some embodiments of the present invention.

FIG. 5C is a comparison diagram of the second image from the NIR sensor in the dark circuit circumstance and the bright circumstance in accordance with some embodiments of the present invention.

FIG. 6 is a schematic diagram of an electronic system 600 in accordance with some embodiments of the present invention.

### DETAILED DESCRIPTION OF THE INVENTION

In order to make the above purposes, features, and advantages of some embodiments of the present invention more comprehensible, the following is a detailed description in conjunction with the accompanying drawing.

Certain terms are used throughout the description and following claims to refer to particular components. As one skilled in the art will understand, electronic equipment manufacturers may refer to a component by different names. This document does not intend to distinguish between components that differ in name but not function. It is understood that the words “comprise”, “have” and “include” are used in an open-ended fashion, and thus should be interpreted to mean “include, but not limited to . . . ”. Thus, when the terms “comprise”, “have” and/or “include” used in the present invention are used to indicate the existence of specific technical features, values, method steps, operations, units and/or components. However, it does not exclude the possibility that more technical features, numerical values, method steps, work processes, units, components, or any combination of the above can be added.

The directional terms used throughout the description and following claims, such as: “on”, “up”, “above”, “down”, “below”, “front”, “rear”, “back”, “left”, “right”, etc., are only directions referring to the drawings. Therefore, the directional terms are used for explaining and not used for limiting the present invention. Regarding the drawings, the drawings show the general characteristics of methods, structures, and/or materials used in specific embodiments. However, the drawings should not be construed as defining or limiting the scope or properties encompassed by these embodiments. For example, for clarity, the relative size, thickness, and position of each layer, each area, and/or each structure may be reduced or enlarged.

When the corresponding component such as layer or area is referred to as being “on another component”, it may be directly on this other component, or other components may exist between them. On the other hand, when the component is referred to as being “directly on another component (or the variant thereof)”, there is no component between them. Furthermore, when the corresponding component is referred to as being “on another component”, the corresponding component and the other component have a disposition relationship along a top-view/vertical direction, the corresponding component may be below or above the other component, and the disposition relationship along the top-view/vertical direction is determined by the orientation of the device.

It should be understood that when a component or layer is referred to as being “connected to” another component or layer, it can be directly connected to this other component or layer, or intervening components or layers may be present. In contrast, when a component is referred to as being “directly connected to” another component or layer, there are no intervening components or layers present.

The electrical connection or coupling described in this disclosure may refer to direct connection or indirect connection. In the case of direct connection, the endpoints of the components on the two circuits are directly connected or connected to each other by a conductor line segment, while in the case of indirect connection, there are switches, diodes, capacitors, inductors, resistors, other suitable components, or a combination of the above components between the endpoints of the components on the two circuits, but the intermediate component is not limited thereto.

The words “first”, “second”, “third”, “fourth”, “fifth”, and “sixth” are used to describe components. They are not used to indicate the priority order of or advance relationship, but only to distinguish components with the same name.

It should be noted that the technical features in different embodiments described in the following can be replaced, recombined, or mixed with one another to constitute another embodiment without departing from the spirit of the present invention.

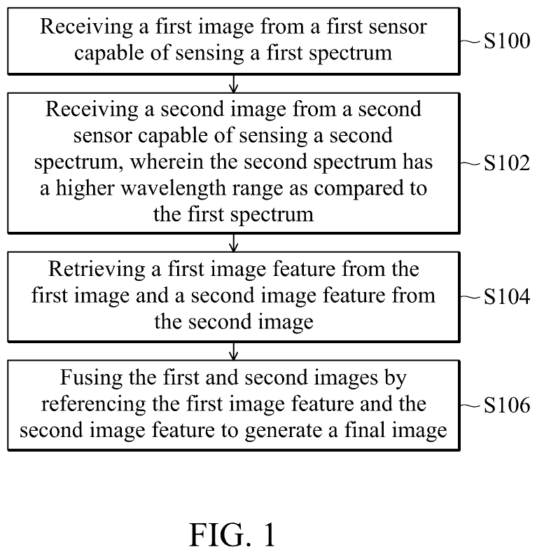

FIG. 1 is a flow chart of a method for high dynamic range (HDR) imaging in accordance with some embodiments of the present invention. As shown in FIG. 1, the method for HDR imaging of the present invention includes the following stages. A first image from a first sensor capable of sensing a first spectrum is received (step S100). A second image from a second sensor capable of sensing a second spectrum is received. The second spectrum has a higher wavelength range as compared to the first spectrum (step S102). A first image feature from the first image and a second image feature from the second image are retrieved (step S104). The first and second images are fused by referencing the first image feature and the second image feature to generate a final image. (step S106). In some embodiments, the method for HDR imaging of the present invention is applied on an electronic system including an RGB light source, an NIR light source, an RGB sensor, an NIR sensor, and a processor. Steps S100, S102, S104, and S106 are performed by the processor, but the present invention is not limited thereto. In some embodiments, the first sensor in step S100 is the RGB sensor. The second sensor in step S102 is the NIR sensor, but the present invention is not limited thereto. In some embodiments, steps S100˜S106 are performed during the transformation from the dark circumstance to the transient circumstance, and to the bright circumstance, but the present invention is not limited thereto. The transformation from the dark circumstance to the transient circumstance, and to the bright circumstance may be the scenario that a person original in a dark room opens the door and walks out to a bright room, but the present invention is not limited thereto.

For example, the dark circumstance may be the scenario that the person still does not open the door of the dark room yet. The transient circumstance may be the moment that the person opens the door. The bright circumstance may be the scenario that the person has walked out the dark room and entered the bright room. In step S100, the RGB sensor may be an RGB camera. The RGB sensor receives the visible light from an RGB light source and/or the reflected visible light from any objects. The RGB sensor outputs the first image according to the received visible light. In some embodiments, the RGB sensor may be disposed in the dark room, but the present invention is not limited thereto. In step S102, the NIR sensor may be an NIR camera. The NIR sensor receives the NIR light from an NIR light source and/or the reflected NIR light from any objects. The NIR sensor outputs the second image according to the received NIR light. In some embodiments, the NIR sensor may be disposed in the dark room, but the present invention is not limited thereto.

In step S104, the first image feature from the first image and the second image feature from the second image may include color information, brightness information, and detail information, but the present invention is not limited thereto. Table 1 show image characteristics output by the RGB sensor and the NIR sensor in both the dark circumstance and the bright circumstance.

TABLE 1

| | RGB sensor | NIR sensor |
|---|---|---|
| Dark | Dirty, colorful | Clear with detail |
| circumstance | | information, non-colorful |
| Bright | Clear, colorful, possible | Clear, not prone to |
| circumstance | for overexposure | overexposure |

As shown in Table 1, in the dark circumstance, the image output by the RGB sensor may be dirty but colorful, and the image output by the NIR sensor may be clear with detail information, but non-colorful. In the bright circumstance, the image output by the RGB sensor may be clear, colorful, but possible for overexposure, and the image output by the NIR sensor may be clear and not prone to overexposure. Based on the image characteristics in Table 1, different features in the respective first image and second image are selected for fusion in step S106. In some embodiments, since the RGB sensor and the NIR sensor are not disposed at the same position, the method for HDR imaging of the present invention further includes performing image alignment on the first image and the second image. In some embodiments, the image alignment is performed before step S106 and after step S102. After the image alignment, the positions in the first image can match with those in the second image.

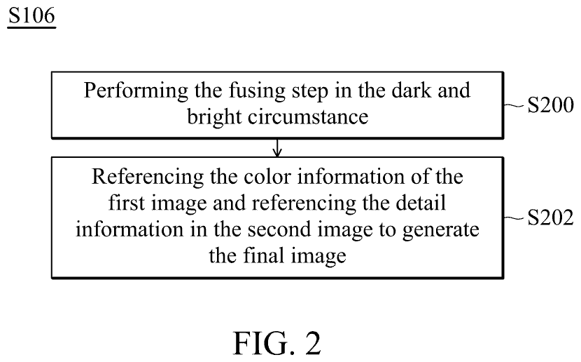

FIG. 2 is a detail flow chart of step S106 of the method for HDR imaging in FIG. 1 in the dark circumstance and the bright circumstance in accordance with some embodiments of the present invention. As shown in FIG. 2, the step S106 in FIG. 1 includes the following stages. The fusing step in the dark and bright circumstances is performed (step S200). The color information of the first image is referenced and the detail information in the second image is referenced to generate the final image (step S202). In some embodiments, the detail information in the first image and the second image may include profiles, textures and edge sharpness, but the present invention is not limited thereto. Table 2 shows the features in the respective first image and the second image fused by the method of the present invention to generate the final image in the dark circumstance, the transient circumstance and the bright circumstance.

TABLE 2

| | RGB sensor | NIR sensor |
|---|---|---|
| | (first image) | (second image) |
| Dark circumstance | Color information | Detail |
| | | information |
| Bright circumstance | Color information, | Parts of detail |
| (not overexposed) | Clear detail | information |
| | information | |
| Bright circumstance | No information | All detail |
| (overexposed) | | information |

As shown in Table 2, in the dark circumstance, the method for HDR imaging of the present invention references the color information of the first image and references the detail information in the second image to generate the final image. In the transient circumstance, some images may be overexposed, and some may not be overexposed. In some embodiments, the method for HDR imaging of the present invention detects the brightness of the first image and the second image. The method for HDR imaging of the present invention references the color information and the detail information in the first image and parts of the detail information in the second image to generate the final image if the brightness information of the first image indicates that the first image is not overexposed. In some embodiments, the method for HDR imaging of the present invention use digital filters to determine where the clear detail information in the first image are. Furthermore, the method for HDR imaging of the present invention utilizes all of the detail information in the second image to generate the final image if the brightness information of the first image indicates that the first image is overexposed. In the bright circumstance that all images are not overexposed, for example, after the person has walked out to the bright room, the method for HDR imaging of the present invention references the color information and the clear detail information in the first image and parts of the detail information in the second image to generate the final image.

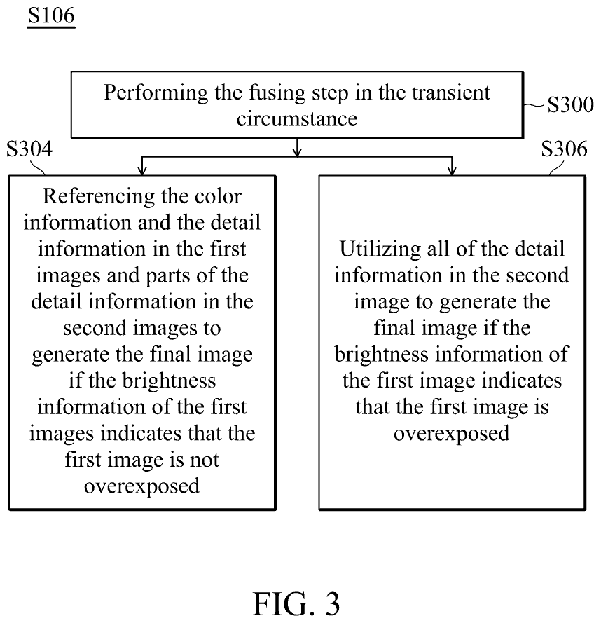

FIG. 3 is a detail flow chart of step S106 of the method for HDR imaging in FIG. 1 in the transient circumstance in accordance with some embodiments of the present invention. As shown in FIG. 3, the step S106 in FIG. 1 includes the following stages. The fusing step in the transient circumstance is performed (step S300). If the brightness information of the first image indicates that the first image is not overexposed, the color information and the detail information in the first image and parts of the detail information in the second image are referenced to generate the final image (step S304). If the brightness information of the first image indicates that the first image is overexposed, all of the detail information in the second image are utilized to generate the final image (step S306). In some embodiments, the detail information in the first image and the second image may include profiles, textures and edge sharpness, but the present invention is not limited thereto.

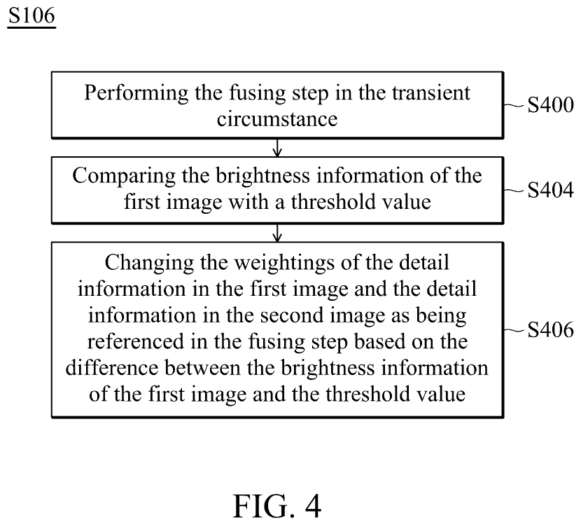

FIG. 4 is a detail flow chart of step S106 of the method for HDR imaging in FIG. 1 in the transient circumstance in accordance with some embodiments of the present invention. As shown in FIG. 4, the step S106 in FIG. 1 includes the following stages. The fusing step in the transient circumstance is performed (step S400). The brightness information of the first image and a threshold value are compared (step S404). The weightings of the detail information in the first image and the detail information in the second image as being referenced in the fusing step are changed based on the difference between the brightness information of the first image and the threshold value (step S406). In some embodiments, in step S404, the method for HDR imaging of the present invention uses a scanning window to compare the brightness pixel by pixel with the threshold value in the scanning window from the left to the right, or from the top to the down of the first and second image, but the present invention is not limited thereto.

In step S406, the greater the difference between the brightness information of the first image and the threshold value, the higher the weighting of the detail information in the first image; the less the difference between the brightness information of the first image and the threshold value, the higher the weighting of the detail information in the second image. In some embodiments, weightings of the color information in the first image and the color information in the second image as being referenced in the fusing step are changed based on the difference between the brightness information of the first image and the threshold value. For example, it is assumed that the threshold value is equal to 255. In some embodiments, the method for HDR imaging of the present invention detects that the brightness information of the first image is equal to 250. The difference between the brightness information of the first image and the threshold value is equal to 5. The method for HDR imaging of the present invention assigns a first weighting on the first image and a second weighting on the second image based on the difference equal to 5. The first weighting is less than the second weighting. Thus, the method for HDR imaging of the present invention takes a first percentage of the features in the first image and a second percentage of the features in the second image to fuse together. The first percentage is equal to the quotient between the first weighting and the summation of the first and second weightings. The second percentage is equal to the quotient between the second weighting and the summation of the first and second weightings.

In some embodiments, the method for HDR imaging of the present invention detects that the brightness of the first image is equal to 155. The difference between the brightness of the first image and the threshold value is equal to 100. The method for HDR imaging of the present invention assigns a third weighting on the first image and a fourth weighting on the second image based on the difference equal to 100. The third weighting is higher than the first weighting, and the fourth weighting is less than the second weighting. Thus, the method for HDR imaging of the present invention takes a third percentage of the features in the first image and a fourth percentage of the features in the second image to fuse together. The third percentage is equal to the quotient between the third weighting and the summation of the third and fourth weightings. The fourth percentage is equal to the quotient between the fourth weighting and the summation of the third and fourth weightings.

Table 3 shows pros and cons of the features in the respective first image and the second image fused by the method of the present invention to generate the final image in the dark circumstance and the bright circumstance.

TABLE 3

| | RGB sensor | NIR sensor | final image |
|---|---|---|---|
| | (first image) | (second image) | (fusing result) |
| exposure | long | short | — |
| Detail information | poor | good | good |
| in the dark | | | |
| circumstance | | | |
| Color information in | yes | no | yes |
| the dark | | | |
| circumstance | | | |
| Transient | overexposed | Slight | Slight |
| circumstance for | | converged | converged |
| opening the door | | | |
| Detail information | slightly | good | good |
| in the bright | overexposed | | |
| circumstance | | | |
| Color information in | good | poor | good |
| the bright | | | |
| circumstance | | | |

As shown Table 3, the exposure of the first image is long, but the exposure of the second image is short. The detail information of the first image in the dark circumstance is poor, but the detail information of the second image in the dark circumstance is good. Thus, the method for HDR imaging of the present invention attaches the detail information from the second image into the final image, so that the final image can show the detail information from the second image. The detail information of the final image is good. The color information from the first image in the dark circumstance is present, but the color information from the second image in the dark circumstance is not present. Thus, the method for HDR imaging of the present invention attaches the color information from the first image into the final image, so that the final image can show the color information from the first image. Furthermore, the first image in the transient circumstance may be overexposed, however, the second image in the transient circumstance may be slight converged. Thus, the method for HDR imaging of the present invention attaches all of the detail information in the second image into the final image if the first image is overexposed, so that the final image is also slight converged, which means that the convergence time in the transient circuit stance for the final image is short.

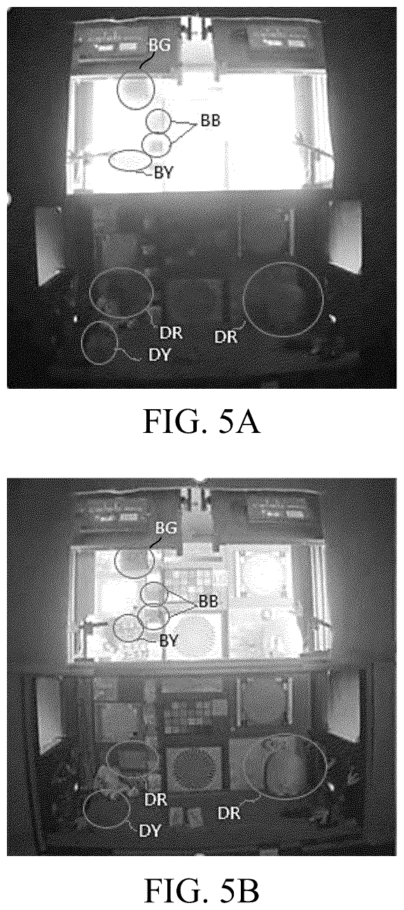

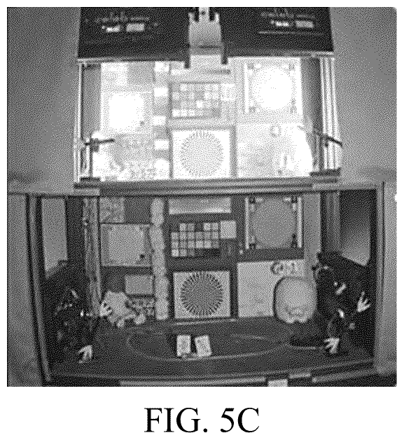

As shown Table 3, the detail information from the first image in the bright circumstance may be slightly overexposed, and the detail information from the second image in the bright circumstance is good. Thus, the method for HDR imaging of the present invention attaches the detail information from the first image and parts of the detail information from the second image into the final image, so that the final image can show the detail information from both the first image and the second image. The detail information of the final image is good. The color information from the first image in the bright circumstance is good, but the color information from the second image in the bright circumstance is poor. Thus, the method for HDR imaging of the present invention attaches the color information from the first image into the final image, so that the final image can show the color information from the first image. The color information of the final image is good. FIG. 5A is a comparison diagram of the first image from the RGB sensor in the dark circuit circumstance and the bright circumstance in accordance with some embodiments of the present invention. As shown in FIG. 5A, the color information marked in the area BG of the first image in the bright circumstance shows the color of bright green. The color information marked in the area BB of the first image in the bright circumstance shows the color of bright blue. The color information marked in the area BY of the first image in the bright circumstance shows the color of bright yellow. The color information marked in the area DR of the first image in the dark circumstance shows the color of dark red. The color information marked in the area DY of the first image in the dark circumstance shows the color of dark yellow. FIG. 5B is a comparison diagram of the final image output by the method for high dynamic range (HDR) imaging of the present invention in the dark circuit circumstance and the bright circumstance in accordance with some embodiments of the present invention. As shown in FIG. 5B, the color information marked in the area BG of the final image in the bright circumstance also shows the color of bright green. The color information marked in the area BB of the final image in the bright circumstance also shows the color of bright blue. The color information marked in the area BY of the final image in the bright circumstance also shows the color of bright yellow. The color information marked in the area DR of the final image in the dark circumstance also shows the color of dark red. The color information marked in the area DY of the final image in the dark circumstance also shows the color of dark yellow. That is, since the exposure of the first image is long, the first image may be overexposed from the dark circumstance to the bright circumstance, the detail information of the first image may be reduced. However, the color information from the first image in the bright circumstance can still be provided to the final image. Similarly, since the exposure of the first image is long, the detail information of the first in the dark circumstance is poor. However, the color information from the first image in the dark circumstance can still be provided to the final image. FIG. 5C is a comparison diagram of the second image from the NIR sensor in the dark circuit circumstance and the bright circumstance in accordance with some embodiments of the present invention. As shown in FIG. 5C, the clear detail information from the second image in both the dark and bright circumstances can be provided to the final image.

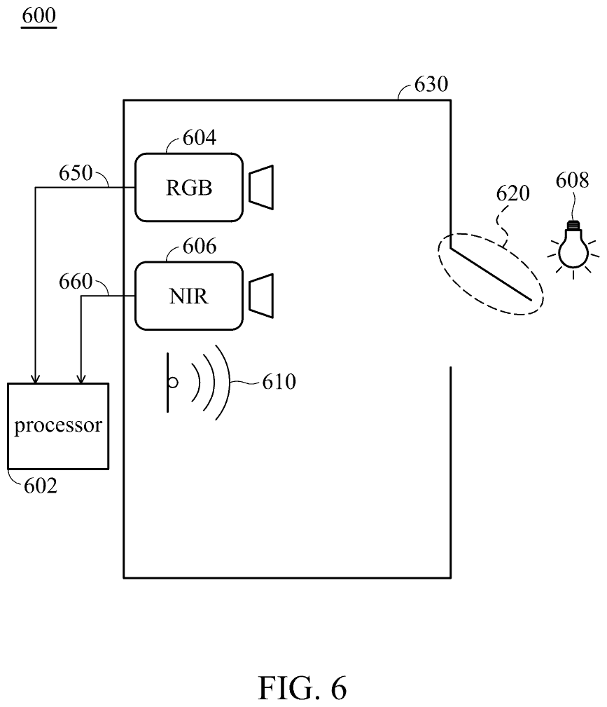

FIG. 6 is a schematic diagram of an electronic system 600 in accordance with some embodiments of the present invention. As shown in FIG. 6, the electronic system 600 includes an RGB light source 608, an NIR light source 610, an RGB sensor 604, an NIR sensor 606, and a processor 602. In some embodiments, the RGB sensor 604, the NIR sensor 606, and the NIR light source 610 are disposed in a dark room 630 with a door 620. The RGB light source 608 is disposed outside the dark room 630. The RGB light source 608 emits visible light. The NIR light source 610 emits NIR light. The RGB sensor 604 outputs first image according to the received visible light to the processor 602 through a communication line 650. The NIR sensor 606 outputs second image according to the received NIR light to the processor 602 through a communication line 660. In some embodiments, the RGB sensor 604 and the NIR sensor 606 sends the first image and the second image to the processor 602 wirelessly, but the present invention is not limited thereto. In some embodiments, the processor 602 performs step S100, step S102, step S104, and step S106 in FIG. 1, steps S200 and S202 in FIG. 2, steps S300, S304, and S306 in FIG. 3, and steps S400, S404, and S406 in FIG. 4.

The transformation from the dark circumstance to the transient circumstance, and to the bright circumstance in steps S100 and S102 may be the scenario that a person original in the dark room 630 opens the door 620 and walks outside the dark room 630, but the present invention is not limited thereto. In detail, the dark circumstance means the scenario that the person still does not open the door 620 of the dark room 630 yet. For example, the transient circumstance may be the moment that the person opens the door 620. The bright circumstance may be the scenario that the person has walked out the dark room 630. In some embodiments, the first image feature from the first image and the second image feature from the second image in step S104 include color information, brightness information, and detail information. In some embodiments, the detail information from the first image and the second image in step S104 include profiles, textures and edge sharpness, but the present invention is not limited thereto. In some embodiments, the processor 602 performs image alignment on the first image from the RGB sensor 604 and the second image from the NIR sensor 606 before retrieving the first image feature and the second image feature.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for high dynamic range (HDR) imaging, comprising:
receiving a first image from a first sensor capable of sensing a first spectrum;
receiving a second image from a second sensor capable of sensing a second spectrum, wherein the second spectrum has a higher wavelength range as compared to the first spectrum;
retrieving a first image feature from the first image and a second image feature from the second image; and
fusing the first and second images by referencing the first image feature and the second image feature to generate a final image.

2. The method as claimed in claim 1, wherein the first image feature and the second image feature comprise color information, brightness information, and detail information.

3. The method as claimed in claim 2, wherein the step of fusing the first image and the second image comprises:
referencing the color information of the first image and referencing the detail information in the second image to generate the final image.

4. The method as claimed in claim 2, wherein the step of fusing the first image and the second image comprises:
referencing the color information and the detail information in the first images and parts of the detail information in the second images to generate the final image if the brightness information of the first images indicates that the first image is not overexposed; and
utilizing all of the detail information in the second image to generate the final image if the brightness information of the first image indicates that the first image is overexposed.

5. The method as claimed in claim 2, wherein the step of fusing the first image and the second image comprises:
comparing the brightness information of the first image with a threshold value; and
changing the weightings of the detail information in the first image and the detail information in the second image as being referenced in the fusing step based on the difference between the brightness information of the first image and the threshold value.

6. The method as claimed in claim 5, wherein the greater the difference between the brightness information of the first image and the threshold value, the higher the weighting of the detail information in the first image; the less the difference between the brightness information of the first image and the threshold value, the higher the weighting of the detail information in the second image.

7. The method as claimed in claim 6, wherein weightings of the color information in the first image and the color information in the second image as being referenced in the fusing step are changed based on the difference between the brightness information of the first image and the threshold value.

8. The method as claimed in claim 2, wherein the detail information comprises profiles, textures and edge sharpness.

9. The method as claimed in claim 1, further comprising:
performing image alignment on the first image and the second image before retrieving the first image feature and the second image feature.

10. An electronic system, comprising:
a first sensor, configured to output a first image according to a first spectrum;
a second sensor, configured to output a second image according to a second spectrum, wherein the second spectrum has a higher wavelength range as compared to the first spectrum; and
a processor, configured to perform the following steps:
receiving the first image from the first sensor capable of sensing the first spectrum;
receiving the second image from the second sensor capable of sensing the second spectrum, wherein the second spectrum has a higher wavelength range as compared to the first spectrum;
retrieving a first image feature from the first image and a second image feature from the second image; and
fusing the first and second images by referencing the first image feature and the second image feature to generate a final image.

11. The electronic system as claimed in claim 10, further comprising:
a light source, configured to emit a light within the second spectrum.

12. The electronic system as claimed in claim 10, wherein the first image feature and the second image feature comprise color information, brightness information, and detail information.

13. The electronic system as claimed in claim 10, wherein the processor references the color information of the first image and references the detail information in the second image to generate the final image.

14. The electronic system as claimed in claim 11, wherein the processor references the color information and the detail information in the first image and parts of the detail information in the second image to generate the final image if the brightness information of the first image indicates that the first image is not overexposed, and utilizes all of the detail information in the second image to generate the final image if the brightness information of the first image indicate that is the first image is overexposed.

15. The electronic system as claimed in claim 11, wherein the processor compares the brightness information of the first image with a threshold value; and changes the weightings of the detail information in the first image and the detail information in the second image as being referenced in the fusing step based on the difference between the brightness information of the first image and the threshold value.

16. The electronic system as claimed in claim 15, wherein the greater the difference between the brightness information of the first image and the threshold value, the higher the weighting of the detail information in the first image; the less the difference between the brightness information of the first image and the threshold value, the higher the weighting of the detail information in the second image.

17. The electronic system as claimed in claim 16, wherein weightings of the color information in the first image and the color information in the second image as being referenced in the fusing step are changed based on the difference between the brightness information of the first image and the threshold value.

18. The electronic system as claimed in claim 12, wherein the detail information comprises profiles, textures and edge sharpness.

19. The electronic system as claimed in claim 10, wherein the processor performs image alignment on the first image and the second image before retrieving the first image feature and the second image feature.
